(19) United States
(12) Patent Application Publication
(10) Pub. No.: US 2026/0202995 A1
(43) Pub. Date: Jul. 16, 2026

(54) MEMORY CONTROL METHOD AND MEMORY STORAGE DEVICE

(71) Applicant: Hefei Kaimeng Technology Co., Ltd., Anhui (CN)

(72) Inventors: Kuai Cao, Anhui (CN); Tsung-Lin Wu, Anhui (CN); Qiao ZHU, Anhui (CN); Ya Jie Guo, Anhui (CN); En Yang Wang, Anhui (CN)

(73) Assignee: Hefei Kaimeng Technology Co., Ltd., Anhui (CN)

(21) Appl. No.: 19/433,968

(22) Filed: Dec. 29, 2025

(30) Foreign Application Priority Data
Jan. 15, 2025 (CN) 202510064717.0

(51) Int. Cl. G06F 3/06

(52) U.S. Cl. CPC G06F 3/0659; G06F 3/0613; G06F 3/0679

(57) ABSTRACT

A memory control method used for a rewritable non-volatile memory module and a memory storage device are provided. The rewritable non-volatile memory module includes entity units. The memory control method includes: selecting target entity units from the entity units, where the target entity units include a first number of first target entity units and a second number of second target entity units; and determining a write mode of a second write operation according to a switching condition when executing a first write operation in a continuous write operation. The second write operation is a next write operation following the first write operation. The write mode includes a first write mode and a second write mode. The first target entity units correspond to the first write mode, and the second target entity units correspond to the second write mode. The first write mode is different from the second write mode.

### CROSS-REFERENCE TO RELATED APPLICATION

This application claims the priority benefit of China application serial no. 202510064717.0, filed on Jan. 15, 2025. The entirety of the above-mentioned patent application is hereby incorporated by reference herein and made a part of this specification.

### BACKGROUND

### Technical Field

The disclosure relates to the field of storage technology, and in particular, relates to a memory control method and a memory storage device.

### Description of Related Art

In recent years, the rapid growth of smart phones, tablet computers, and personal computers has led to a rapid increase in consumer demand for storage media. Rewritable non-volatile memory modules (e.g., flash memory) exhibit the characteristics of data non-volatility, power saving, small sizes, and no mechanical structures. Therefore, the rewritable non-volatile memory modules are suitable for being built into the various above-mentioned portable multimedia devices.

In the field of storage technology, a fixed write mode is adopted most of the time to perform continuous write operations, which causes large fluctuations in write speed. Therefore, how to maintain the stability of data write speed is a key research topic for a person having ordinary skill in the art.

### SUMMARY

Exemplary embodiments of the disclosure provide a memory control method and a memory storage device capable of maintaining the stability of a write speed.

An exemplary embodiment of the disclosure provides a memory control method for a rewritable non-volatile memory module. The rewritable non-volatile memory module includes a plurality of entity units. The memory control method includes the following steps. A plurality of target entity units are selected from the entity units. The target entity units include a first number of first target entity units and a second number of second target entity units. A write mode of a second write operation is determined according to a switching condition when a first write operation in a continuous write operation is executed. The second write operation is a next write operation following the first write operation. The write mode includes a first write mode and a second write mode. The first target entity units correspond to the first write mode, and the second target entity units correspond to the second write mode. The first write mode is different from the second write mode.

In an exemplary embodiment of the disclosure, the memory control method further includes the following steps. A first write speed, a second write speed, and a target write speed corresponding to the continuous write operation are obtained before executing the continuous write operation. A first ratio is calculated according to the target write speed, the first write speed, and the second write speed.

In an exemplary embodiment of the disclosure, the first write speed is a write speed needed to complete the continuous write operation in the first write mode, and the second write speed is a write speed needed to complete the continuous write operation in the second write mode.

In an exemplary embodiment of the disclosure, the step of determining the write mode of the second write operation according to the switching condition includes the following steps. A first amount of data of the first target entity units and a second amount of data of the second target entity units are obtained. A second ratio is calculated according to the first amount of data and the second amount of data. The write mode of the second write operation is determined according to the first ratio and the second ratio.

In an exemplary embodiment of the disclosure, the first amount of data is a written amount of data of the first target entity units, and the second amount of data is a written amount of data of the second target entity units.

In an exemplary embodiment of the disclosure, the target entity units have a plurality of pieces of logic-to-entity information used to record a written order of the target entity units and a mapping relationship between entity addresses and logic addresses of the target entity units.

In an exemplary embodiment of the disclosure, after the second target entity units are fully written, the first target entity units are no longer used to store data.

In an exemplary embodiment of the disclosure, the memory control method further includes the following step. A latest entity address among the entity addresses is queried according to the written order of the target entity units in the logic-to-entity information if the logic addresses are mapped to the entity addresses of the target entity units.

In an exemplary embodiment of the disclosure, the memory control method further includes the following step. During the execution of the continuous write operation, a first switching time table and a second switching time table are established. The first switching time table is used to record an entity address and a timestamp corresponding to latest data stored in the second target entity units when the second write mode is switched to the first write mode. The second switching time table is used to record an entity address and a timestamp corresponding to latest data stored in the first target entity units when the first write mode is switched to the second write mode.

In an exemplary embodiment of the disclosure, the memory control method further includes the following steps. The entity addresses are queried from the logic-to-entity information if the logic addresses are mapped to the entity addresses of the target entity units. A plurality of timestamps corresponding to the entity addresses are queried from at least one of the first switching time table and the second switching time table. A latest entity address among the entity addresses is determined according to the timestamps.

An exemplary embodiment of the disclosure further provides a memory storage device including a connection interface unit, a rewritable non-volatile memory module, and a memory control circuit unit. The memory control circuit unit is coupled to the connection interface unit and the rewritable non-volatile memory module. The connection interface unit is configured to be coupled to a host system. The rewritable non-volatile memory module includes a plurality of entity units. The memory control circuit unit is configured to select a plurality of target entity units from the entity units. The target entity units include a first number of first target entity units and a second number of second target entity units. The memory control circuit unit is further configured to determine a write mode of a second write operation according to a switching condition when executing a first write operation in a continuous write operation. The second write operation is a next write operation following the first write operation. The write mode includes a first write mode and a second write mode. The first target entity units correspond to the first write mode, and the second target entity units correspond to the second write mode. The first write mode is different from the second write mode.

In an exemplary embodiment of the disclosure, before executing the continuous write operation, the memory control circuit unit is further configured to obtain a first write speed, a second write speed, and a target write speed corresponding to the continuous write operation and calculate a first ratio according to the target write speed, the first write speed, and the second write speed.

In an exemplary embodiment of the disclosure, the memory control circuit unit is further configured to obtain a first amount of data of the first target entity units and a second amount of data of the second target entity units. The memory control circuit unit is further configured to calculate a second ratio according to the first amount of data and the second amount of data. The memory control circuit unit is further configured to determine the write mode of the second write operation according to the first ratio and the second ratio.

In an exemplary embodiment of the disclosure, the memory control circuit unit is further configured to query a latest entity address among the entity addresses according to the written order of the target entity units in the logic-to-entity information if the logic addresses are mapped to the entity addresses of the target entity units.

In an exemplary embodiment of the disclosure, during the execution of the continuous write operation, the memory control circuit unit is further configured to establish a first switching time table and a second switching time table. The first switching time table is used to record an entity address and a timestamp corresponding to latest data stored in the second target entity units when the second write mode is switched to the first write mode. The second switching time table is used to record an entity address and a timestamp corresponding to latest data stored in the first target entity units when the first write mode is switched to the second write mode.

In an exemplary embodiment of the disclosure, the memory control circuit unit is further configured to query the entity addresses from the logic-to-entity information if the logic addresses are mapped to the entity addresses of the target entity units. The memory control circuit unit is further configured to query a plurality of timestamps corresponding to the entity addresses from at least one of the first switching time table and the second switching time table. The memory control circuit unit is further configured to determine a latest entity address among the entity addresses according to the timestamps.

To sum up, in the memory control method and the memory storage device provided by the disclosure, by executing the continuous write operation on the target entity units and appropriately switching the write modes of the continuous write operation, the write speed is controlled within a small amount of data (that is, the amount of write data corresponding to the continuous write operation), and the stability of the write speed is thus improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a host system, a memory storage device, and an input/output (I/O) device according to an exemplary embodiment of the disclosure.

FIG. 2 is a schematic view illustrating the host system, the memory storage device, and the I/O device according to an exemplary embodiment of the disclosure.

FIG. 3 is a schematic view illustrating a host system and a memory storage device according to an exemplary embodiment of the disclosure.

FIG. 4 is a schematic view illustrating the memory storage device according to an exemplary embodiment of the disclosure.

FIG. 5 is a schematic view illustrating a memory control circuit unit according to an exemplary embodiment of the disclosure.

FIG. 6 is a flow chart illustrating a memory control method according to an exemplary embodiment of the disclosure.

FIG. 7 is a schematic view illustrating a first open pool and a second open pool according to an exemplary embodiment of the disclosure.

FIG. 8 is a schematic chart of logic-to-entity information according to an exemplary embodiment of the disclosure.

FIG. 9 is a schematic chart of a first switching time table and a second switching time table according to an exemplary embodiment of the disclosure.

FIG. 10 is a flow chart illustrating a memory control method according to an exemplary embodiment of the disclosure.

### DESCRIPTION OF THE EMBODIMENTS

Descriptions of the disclosure are given with reference to the exemplary embodiments illustrated by the accompanying drawings. Wherever possible, the same reference numerals are used in the drawings and the description to refer to the same or like parts.

Generally, a memory storage device (aka a memory storage system) includes a rewritable non-volatile memory module and a controller (aka a control circuit). The memory storage device may be used together with a host system, so the host system may write data into or read data from the memory storage device.

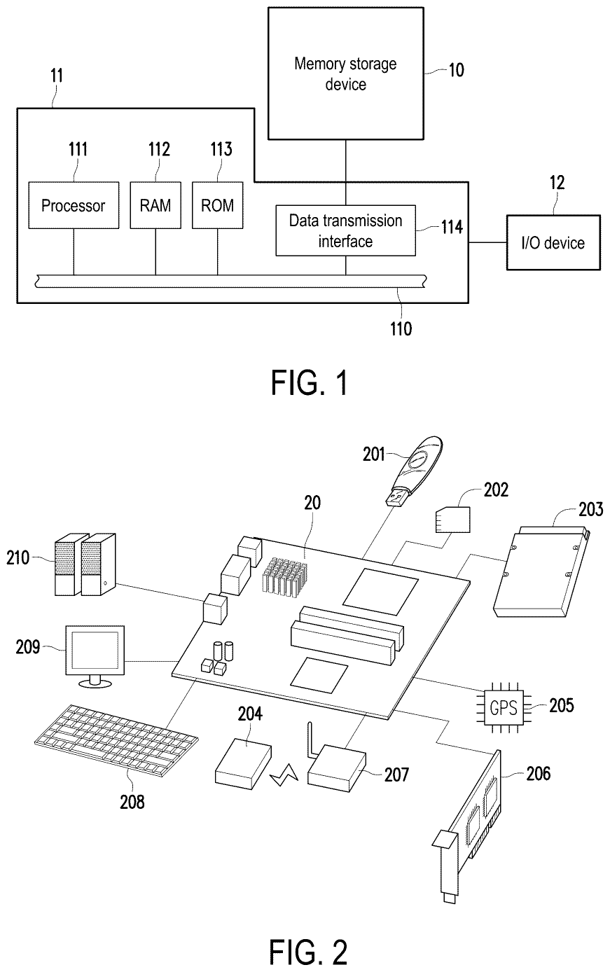

FIG. 1 is a schematic view illustrating a host system, a memory storage device, and an input/output (I/O) device according to an exemplary embodiment of the disclosure. FIG. 2 is a schematic view illustrating the host system, the memory storage device, and the I/O device according to an exemplary embodiment of the disclosure.

With reference to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be coupled to a system bus 110.

In an exemplary embodiment, the host system 11 may be coupled to a memory storage device 10 through the data transmission interface 114. For instance, the host system 11 may store data into the memory storage device 10 or may read data from the memory storage device 10 through the data transmission interface 114. Further, the host system 111 may be coupled to an I/O device 12 through the system bus 110. For instance, the host system 11 may transmit an output signal to the I/O device 12 or receive an input signal from the I/O device 12 through the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or plural. Through the data transmission interface 114, the motherboard 20 may be coupled to the memory storage device 10 through wired or wireless methods.

In an exemplary embodiment, the memory storage device 10 may be, for example, a flash drive 201, a memory card 202, a solid state drive (SSD) 203, or a wireless memory storage device 204. The wireless memory storage device 204 may be, for example, a memory storage device based on various wireless communication technologies, such as a near field communication (NFC) memory storage device, a wireless fidelity (WiFi) memory storage device, a Bluetooth memory storage device, or a low energy Bluetooth memory storage device (e.g., iBeacon). Besides, the motherboard 20 may also be coupled to various I/O devices including a global positioning system (GPS) module 205, a network interface card 206, a wireless transmission device 207, a keyboard 208, a display 209, and a speaker 210 through the system bus 110. For instance, in an exemplary embodiment, the motherboard 20 may access the wireless memory storage device 204 through the wireless transmission device 207.

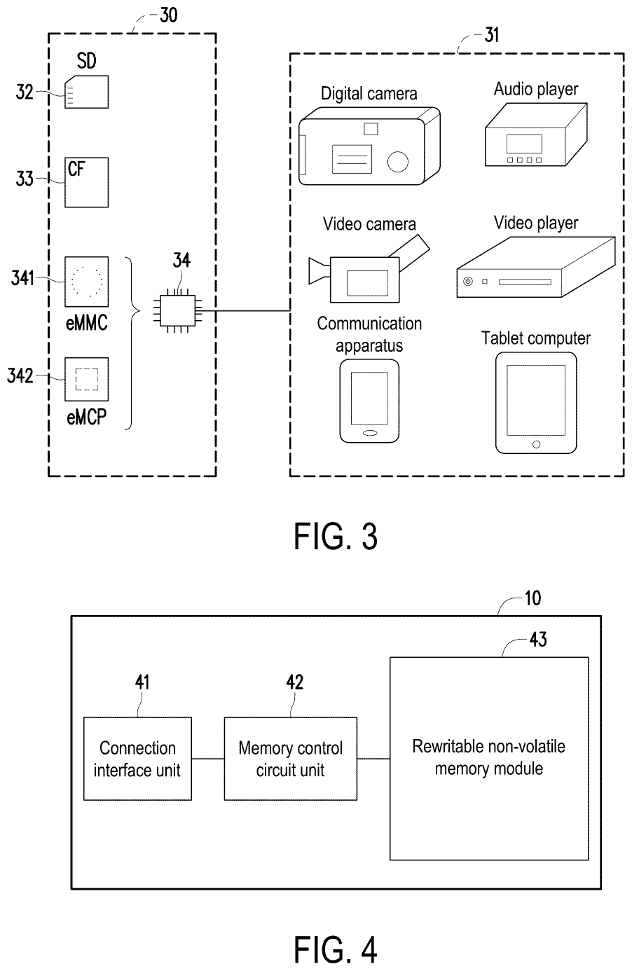

In an exemplary embodiment, the host system 11 may be a computer system. In an exemplary embodiment, the host system 11 may be any system capable of substantially cooperating with the memory storage device for storing data. In an exemplary embodiment, the host system 11 may be a vehicle-mounted system. In an exemplary embodiment, the memory storage device 10 and the host system 11 may include a memory storage device 30 and a host system 31 of FIG. 3 respectively.

FIG. 3 is a schematic view illustrating a host system and a memory storage device according to an exemplary embodiment of the disclosure.

With reference to FIG. 3, the memory storage device 30 may be used together with the host system 31 to store data. For instance, the host system 31 may be a system such as a digital camera, a video camera, a communication apparatus, an audio player, a video player, or a tablet computer. For instance, the memory storage device 30 may be a non-volatile memory storage device used by the host system 31, such as a secure digital (SD) card 32, a compact flash (CF) card 33, or an embedded storage device 34. The embedded storage device 34 includes various embedded storage devices capable of directly coupling a memory module onto a substrate of the host system, such as an embedded Multi Media Card (eMMC) 341 and/or an embedded Multi Chip Package (eMCP) storage device 342.

FIG. 4 is a schematic view illustrating the memory storage device according to an exemplary embodiment of the disclosure.

With reference to FIG. 4, the memory storage device 10 includes a connection interface unit 41, a memory control circuit unit 42, and a rewritable non-volatile memory module 43.

The connection interface unit 41 is configured to couple the memory storage device 10 to the host system 11. The memory storage device 10 may communicate with the host system 11 through the connection interface unit 41. In an exemplary embodiment, the connection interface unit 41 is compatible with the peripheral component interconnect express (PCI Express) standard. In an exemplary embodiment, the connection interface unit 41 may also comply with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the Secure Digital (SD) interface standard, the Ultra High Speed-I (UHS-I) interface standard, the Ultra High Speed-II (UHS-II) interface standard, the Memory Stick (MS) interface standard, the Multi Chip Package (MCP) interface standard, the Multi Media Card (MMC) interface standard, the embedded Multi Media Card (eMMC) interface standard, the Universal Flash Storage (UFS) interface standard, the embedded Multi Chip Package (eMCP) interface standard, the Compact Flash (CF) interface standard, the Integrated Device Electronics (IDE) interface standard, or other applicable standards. The connection interface unit 41 may be packaged in a chip together with the memory control circuit unit 42, or the connection interface unit 41 may be disposed outside a chip including the memory control circuit unit 42.

The memory control circuit unit 42 is coupled to the connection interface unit 41 and the rewritable non-volatile memory module 43. The memory control circuit unit 42 is configured to implement a plurality of logic gates or control instructions which are implemented in a form of hardware or firmware and to execute operations of data writing, reading, or erasing in the rewritable non-volatile memory module 43 according to the instructions of the host system 11.

The rewritable non-volatile memory module 43 is configured to store data written by the host system 11. The rewritable non-volatile memory module 43 may include a single level cell (SLC) NAND flash memory module (i.e., a flash memory module capable of storing 1 bit in one memory cell), a multi level cell (MLC) NAND flash memory module (i.e., a flash memory module capable of storing 2 bits in one memory cell), a triple level cell (TLC) NAND flash memory module (i.e., a flash memory module capable of storing 3 bits in one memory cell), a quad level cell (QLC) NAND flash memory module (i.e., a flash memory module capable of storing 4 bits in one memory cell), other flash memory modules, or any memory module having the same features.

Each memory cell in the rewritable non-volatile memory module 43 stores one bit or more bits with a change in voltage (referred to as “threshold voltage” hereinafter). Specifically, a charge trapping layer is provided between a control gate of each memory cell and a channel. By applying a write voltage to the control gate, the amount of electrons of the charge trapping layer may be changed, and a threshold voltage of the memory cell is thereby changed. The operation of changing the threshold voltage of the memory cell is also referred to as “writing data to the memory cell” or “programming the memory cell”. Each memory cell in the rewritable non-volatile memory module 43 has a plurality of storage states according to the change of the threshold voltage. The storage state of the memory cell may be determined by applying a reading voltage, and the one or more bits stored in the memory cell is thereby obtained.

In an exemplary embodiment, the memory cells of the rewritable non-volatile memory module 43 may form a plurality of entity programming units, and the entity programming units may form a plurality of entity units. Specifically, the memory cells on a same word line may form one entity programming unit or a plurality of entity programming units. If each of the memory cells stores 2 bits or more bits, the entity programming units on the same word line may at least be categorized as a lower entity programming unit and an upper entity programming unit. For instance, a least significant bit (LSB) of one memory cell belongs to the lower entity programming unit, and a most significant bit (MSB) of one memory cell belongs to the upper entity programming unit. Generally, in an MLC NAND flash memory, a write speed of the lower entity programming unit may be greater than a write speed of the upper entity programming unit, and/or reliability of the lower entity programming unit is greater than reliability of the upper entity programming unit.

In an exemplary embodiment, the entity programming units are the smallest units for programming. That is, the entity programming units are the minimum units for write data. For instance, the entity programming units may be entity pages or entity sectors. When the entity programming units are the entity pages, these entity programming units may include a data bit region and a redundancy bit region. The data bit region includes a plurality of entity sectors configured to store user data, and the redundancy bit region is configured to store system data (e.g., management data such as an error correcting code). In an exemplary embodiment, the data bit region includes 32 entity sectors, and a size of each of the entity sectors is 512 bytes (B). However, in other exemplary embodiments, the data bit region may also include 8, 16, or more or fewer entity sectors. The size of each of the entity sectors may be greater or smaller. On the other hand, the entity units are the minimum units for erasing. That is, each of the entity units contains the least number of memory cells to be erased together. The entity units are entity blocks, for example.

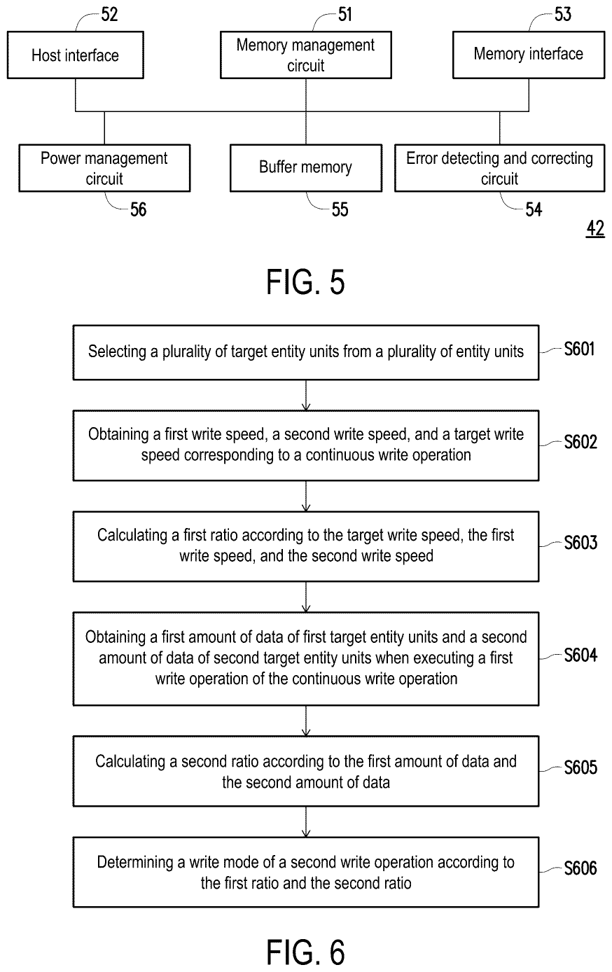

FIG. 5 is a schematic view illustrating a memory control circuit unit according to an exemplary embodiment of the disclosure.

With reference to FIG. 5, the memory control circuit unit 42 includes a memory management circuit 51, a host interface 52, and a memory interface 53.

The memory management circuit 51 is configured to control an overall operation of the memory control circuit unit 42. Specifically, the memory management circuit 51 has a plurality of control instructions. When the memory storage device 10 runs, these control instructions are executed to perform various operations such as data writing, data reading, and data erasing. The following description of the operation of the memory management circuit 51 is equivalent to the description of the operation of the memory control circuit unit 42.

In an exemplary embodiment, the control instructions of the memory management circuit 51 are implemented in a form of firmware. For instance, the memory management circuit 51 has a microprocessor unit (not shown) and a read-only memory (not shown), and these control instructions are burnt into the read-only memory. When the memory storage device 10 works, these control instructions are executed by the microprocessor unit to perform various operations, such as data writing, data reading, and data erasing.

In an exemplary embodiment, the control instructions of the memory management circuit 51 may also be stored in a specific region (for example, a system region in the memory module exclusively used for storing system data) of the rewritable non-volatile memory module 43 in the form of codes. Moreover, the memory management circuit 51 has the microprocessor unit (not shown), the read-only memory (not shown), and a random access memory (not shown). In particular, this read-only memory has a boot code, and when the memory control circuit unit 42 is enabled, the boot code is executed by the microprocessor unit first for loading the control instructions stored in the rewritable non-volatile memory module 43 to the random access memory of the memory management circuit 51. After that, the microprocessor unit executes these control instructions to perform various operations such as data writing, data reading, and data erasing.

In an exemplary embodiment, the control instructions of the memory management circuit 51 may also be implemented in a hardware form. For instance, the memory management circuit 51 includes a microprocessor, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microprocessor. The memory cell management circuit is configured to manage the memory cells or memory cell groups of the rewritable non-volatile memory module 43. The memory writing circuit is configured to issue a write instruction sequence to the rewritable non-volatile memory module 43 so as to write data into the rewritable non-volatile memory module 43. The memory reading circuit is configured to issue a read instruction sequence to the rewritable non-volatile memory module 43 so as to read data from the rewritable non-volatile memory module 43. The memory erasing circuit is configured to issue an erase instruction sequence to the rewritable non-volatile memory module 43 so as to erase data from the rewritable non-volatile memory module 43. The data processing circuit is configured to process data to be written into the rewritable non-volatile memory module 43 and data to be read from the rewritable non-volatile memory module 43. Each of the write instruction sequence, the read instruction sequence, and the erase instruction sequence may include one or more codes or instruction codes and is configured to instruct the rewritable non-volatile memory module 43 to execute corresponding operations such as writing, reading, and erasing. In an exemplary embodiment, the memory management circuit 51 may further issue other types of instruction sequences to the rewritable non-volatile memory module 43 to instruct the execution of corresponding operations.

The host interface 52 is coupled to the memory management circuit 51. The memory management circuit 51 may communicate with the host system 11 through the host interface 52. The host interface 52 may be configured to receive and identify an instruction and data sent from the host system 11. For instance, the instruction and the data sent from the host system 11 may be transmitted to the memory management circuit 51 through the host interface 52. In addition, the memory management circuit 51 may transmit the data to the host system 11 through the host interface 52. In this exemplary embodiment, the host interface 52 is compatible with the PCI Express standard. However, it should be understood that the disclosure is not limited thereto, and the host interface 52 may also be compatible to the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other applicable standards for data transmission.

The memory interface 53 is coupled to the memory management circuit 51 and is configured to access the rewritable non-volatile memory module 43. For instance, the memory management circuit 51 may access the rewritable non-volatile memory module 43 through the memory interface 53. In other words, data to be written to the rewritable non-volatile memory module 43 is converted into a format acceptable to the rewritable non-volatile memory module 43 through the memory interface 53. Specifically, when the memory management circuit 51 is to access the rewritable non-volatile memory module 43, the memory interface 53 sends corresponding instruction sequences. For instance, the instruction sequences may include a write instruction sequence instructing data-writing, a read instruction sequence instructing data-reading, an erase instruction sequence instructing data-erasing, as well as corresponding instruction sequences configured to instruct various memory operations (e.g., changing a reading voltage level or executing garbage collection, etc.). The instruction sequences are generated by, for example, the memory management circuit 51, and are sent to the rewritable non-volatile memory module 43 through the memory interface 53. These instruction sequences may include one or more signals or data on the bus. These signals or data may include instruction codes or codes. For instance, in the read instruction sequence, information such as a read identification code and a memory address may be included.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute an error detecting and correcting operation to ensure the correctness of data. To be specific, when the memory management circuit 51 receives a write instruction from the host system 11, the error detecting and correcting circuit 54 generates a corresponding error correcting code (ECC) and/or an error detecting code (EDC) for the data corresponding to the write instruction, and the memory management circuit 51 writes the data corresponding to the write instruction and the corresponding error correcting code and/or the error detecting code to the rewritable non-volatile memory module 43. After that, when the memory management circuit 51 reads the data from the rewritable non-volatile memory module 43, the corresponding error correcting code and/or the error detecting code is read simultaneously, and the error detecting and correcting circuit 54 executes an error detecting and correcting operation for the read data based on the error correcting code and/or the error detecting code.

The buffer memory 55 is coupled to the memory management circuit 51 and is used to temporarily store data. The power management unit 56 is coupled to the memory management circuit 51 and is configured to control power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

In a memory storage device 10 of the related art, the storage space of the rewritable non-volatile memory module 43 is managed by using a single open block as a unit most of the time. However, this open block is single and is fixed, for example, being written based on a single level cell (SLC) write mode or being written based on a triple level cell (TLC) write mode. The manner of managing the storage space by using a single open block as a unit makes it difficult to respond to the demand of continuous write operations, and the write speed is thereby affected.

As such, the disclosure provides a memory management method capable of managing the storage space of the rewritable non-volatile memory module 43 by using a plurality of target entity units as units and appropriately switching write modes for a continuous write operation during a process of performing the continuous write operation. In this way, the write speed may be controlled within a small amount of data (that is, an amount of write data corresponding to the continuous write operation), and the stability of the write speed is thus improved.

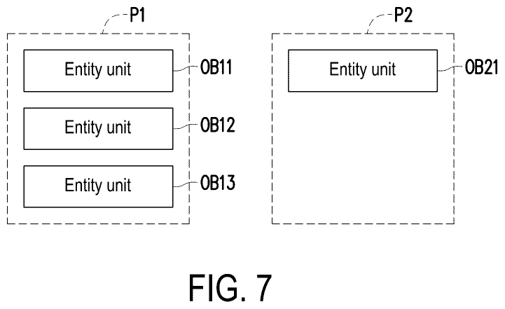

FIG. 6 is a flow chart illustrating a memory control method according to an exemplary embodiment of the disclosure. FIG. 7 is a schematic view illustrating a first open pool and a second open pool according to an exemplary embodiment of the disclosure.

Referring to FIG. 6 and FIG. 7, in step S601, the memory management circuit 51 may select a plurality of target entity units OB11 to OB13 and OB21 from a plurality of entity units. In an exemplary embodiment, each of the target entity units OB11 to OB13 and OB21 is, for example, an entity erase unit (e.g., an entity block).

In an exemplary embodiment, as shown in FIG. 7, the target entity units OB11 to OB13 and OB21 include a first number of (e.g., 3) first target entity units OB11 to OB13 and a second number of (e.g., 1) second target entity unit OB21. The first target entity units OB11 to OB13 correspond to a first write mode. For instance, the first target entity units OB11 to OB13 may be written based on a single level cell (SLC) write mode. The second target entity unit OB21 corresponds to a second write mode. For instance, the second target entity unit OB21 may be written based on a second level cell (multi level cell (MLC)) write mode, a triple level cell (TLC) write mode, or a quad level cell (QLC) write mode. The first write mode is different from the second write mode. The first target entity units OB11 to OB13 are associated with a first open pool P1. The second target entity unit OB21 is associated with a second open pool P2. That is, the memory management circuit 51 may manage the storage space of the rewritable non-volatile memory module 43 by using 3 first target entity units OB11 to OB13 and 1 second target entity unit OB21 as units.

In step S602, the memory management circuit 51 may obtain a first write speed, a second write speed, and a target write speed corresponding to a continuous write operation.

In an exemplary embodiment, the memory management circuit 51 may determine the first write speed, the second write speed, and the target write speed according to, for example, historical write data, user usage habits, and/or performance of the memory storage device 10. Specifically, the first write speed is a write speed needed to complete the continuous write operation in the first write mode (e.g., the SLC write mode), and the second write speed is a write speed needed to complete the continuous write operation in the second write mode (e.g., the TLC write mode).

Further, the memory management circuit 51 may calculate an average write speed required for the memory storage device 10 to complete the continuous write operation using only a single target entity unit according to, for example, the historical write data, the user usage habits, and/or the performance of the memory storage device 10. For instance, the average write speed required to complete the continuous write operation using only a single target entity unit corresponding to the SLC write mode is the first write speed. For instance, the average write speed required to complete the continuous write operation using only a single target entity unit corresponding to the TLC write mode is the second write speed. Accordingly, the memory management circuit 51 may establish the target write speed required to complete the continuous write operation using the target entity units corresponding to the different write modes according to the first write speed and the second write speed. Alternatively, the target write speed may also be designed by a user according to needs, which is not limited by the disclosure.

In step S603, the memory management circuit 51 may calculate a first ratio according to the target write speed, the first write speed, and the second write speed.

In an exemplary embodiment, since write operations corresponding to different write modes have different write speeds, when a continuous write operation is executed, unstable write speed problems may occur. In the process of executing a continuous write operation, in order to achieve an effect of having the same write speed (i.e., the target write speed) in different write modes, the memory management circuit 51 may calculate a first ratio, to serve as a basis for switching operation modes, according to the first write speed, the second write speed, and the target write speed. The first ratio may be obtained by formula (1) and formula (2).

$$target write speed = \frac{X + Y}{\frac{X}{first write speed} + \frac{Y}{second write speed}} \qquad Formula ( 1 )$$

$$and$$

$$first ratio = \frac{X}{Y} , \qquad Formula ( 2 )$$

where X represents the amount of data (capacity of entity pages) in the single level cell (SLC) mode, and Y represents the amount of data (capacity of entity pages) in the triple level cell (TLC) mode.

In an exemplary embodiment, in the process of executing the continuous write operation, the memory management circuit 51 may first write the write data into the target entity unit OB21 based on the TLC write mode, and after writing the write data with an amount of data of Y into the target entity unit OB21, the memory management circuit 51 then switches the write mode to the SLC write mode. Thereafter, after writing the write data with an amount of data of X into the target entity unit OB11 (or the target entity unit OB12 or the target entity unit OB13), the memory management circuit 51 then switches the write mode to the TLC write mode again, and this is repeated until the continuous write operation is completed. In this way, the memory management circuit 51 may maintain the write speed of the continuous write operation at the target write speed by using the target entity units OB11 to OB13 and OB21, so that the stability of the write speed is ensured.

For instance, assuming that the rewritable non-volatile memory module 43 is a triple level cell (TLC) NAND-type flash memory module, and the rewritable non-volatile memory module 43 has 4 entity planes and 4,000 entity pages. If the target write speed corresponding to the continuous write operation is 200 MB/s, the first write speed is 250 MB/s, and the second write speed is 100 MB/s, substituting into formula (1) and formula (2), it can be deduced that the first ratio is 5. It should be noted that the minimum write unit of the TLC NAND-type flash memory is 3 entity pages. These 3 entity pages are a lower page, a middle page, and an upper page. A capacity of one entity page may be, for example, 16 KB, so the minimum write amount is 16*3=48 KB. Since the rewritable non-volatile memory module 43 has 4 entity planes, the total write amount is 48*4=192 KB.

That is, in the process of executing the continuous write operation, the memory management circuit 51 may first write the write data into the first 3 entity pages in the target entity unit OB21 based on the TLC write mode, and after switching the write mode to the SLC write mode to write the write data into the first 3*5=15 entity pages in the target entity unit OB11 (or the target entity unit OB12 or the target entity unit OB13), the memory management circuit 51 switches the write mode to the TLC write mode again, and this is repeated until the continuous write operation is completed, so as to maintain the write speed of the continuous write operation at the target write speed (i.e., 200 MB/s).

Further, in order to maintain the write speed of the continuous write operation at or above the target write speed (i.e., 200 MB/s), the memory management circuit 51 may switch to the TLC write mode to write an amount of data of 192 KB after writing an amount of data of 192*5=960 KB in the SLC write mode and then switch back to the SLC write mode, and this is repeated until the continuous write operation is completed. Accordingly, the amount of data corresponding to one complete write cycle is 192+960=1152 KB. In other words, the amount of data (chunk size) corresponding to one complete write cycle is approximately equal to 1 MB (i.e., 1024 KB). Therefore, in the memory control method of the disclosure, balanced and stable control of the write speed of the amount of data corresponding to one complete write cycle at 200 MB/s is achieved.

However, if the write speed is controlled by using the amount of data of one entity unit (e.g., one open block) as a unit in the conventional manner, there may be a problem of large fluctuations in the write speed caused by multiple switches of entity erase units in different modes.

It should be noted that in a conventional 2D NAND flash memory, one entity block includes, for example, 32 to 128 entity pages, where the capacity of each entity page is, for example, 4096 B to 8192 B. Compared to a 3D NAND flash memory, due to structural differences, the sizes (capacities) of the entity blocks may be different. Specifically, the capacity of one entity block of the 3D NAND flash memory may reach 16 MB. Accordingly, whether it is the capacity of one entity block in a 2D NAND flash memory or the capacity of one entity block in a 3D NAND flash memory, both are greater than the aforementioned amount of data (chunk size, i.e., 1 MB) of one complete write cycle.

According to the above, the manner of controlling the write speed by using the chunk size as a unit provided by the exemplary embodiments of the disclosure helps to improve the write efficiency and reduce write amplification. Meanwhile, the manner of controlling the write speed at the target write speed (200 MB/s) to write data into the first target entity units and the second target entity unit in an alternating manner may balance the write load, so that the performance of the memory storage device 10 is improved. In addition, the manner of writing data into the first target entity units and the second target entity unit in an alternating manner also helps to achieve more uniform wear distribution and avoid excessive wear of specific entity units, so that the reliability and durability of the memory storage device 10 are improved.

In step S604, the memory management circuit 51 may obtain a first amount of data of the first target entity units OB11 to OB13 and a second amount of data of the second target entity unit OB21 when executing a first write operation of the continuous write operation.

In an exemplary embodiment, during the process of executing the continuous write operation, the memory management circuit 51 sequentially executes multiple write operations. In other words, the continuous write operation includes multiple write operations. When the memory management circuit 51 executes the first write operation (i.e., a current write operation) in the continuous write operation, the memory management circuit 51 may determine the write mode of the next write operation (i.e., a second write operation) according to a switching condition (i.e., the aforementioned first ratio), so as to maintain the write speed of the continuous write operation at the target write speed.

Assuming that the first write operation is the first write operation in the continuous write operation, during the process of the first write operation, the memory management circuit 51 may first write the write data corresponding to the first write operation in the continuous write operation into the first three entity pages of the target entity unit OB21 based on the TLC write mode and obtain the first amount of data of the first target entity units OB11 to OB13 and the second amount of data of the second target entity unit OB21. The first amount of data is the amount of data written into the first target entity units OB11 to OB13, and the second amount of data is the amount of data written into the second target entity unit OB21. At this point, the first amount of data of the first target entity units OB11 to OB13 is the capacity of 0 entity pages, and the second amount of data of the second target entity unit OB21 is the capacity of 3 entity pages.

In step S605, the memory management circuit 51 may calculate a second ratio according to the first amount of data and the second amount of data.

In an exemplary embodiment, the second ratio may be, for example, a ratio of the first amount of data to the second amount of data. For instance, during the process of the aforementioned first write operation, the second ratio is a ratio of the capacity of 0 entity pages to the capacity of 3 entity pages, which is 0.

In step S606, the memory management circuit 51 may determine the write mode of the second write operation according to the first ratio and the second ratio.

In an exemplary embodiment, assuming that the first ratio is 1, and during the process of executing the continuous write operation, the memory management circuit 51 needs to write the write data into the target entity units OB11 to OB13 and OB21 according to the first ratio in order to maintain the stability of the write speed. Therefore, after writing the write data into three entity pages in the target entity unit OB21 in the TLC write mode, the memory management circuit 51 needs to switch to the SLC write mode to write the write data into three entity pages of the target entity units OB11 to OB13 before switching back to the TLC write mode, and this is repeated until the continuous write operation is completed. Accordingly, during the process of executing the continuous write operation, the memory management circuit 51 may determine the write mode of the second write operation by comparing the second ratio and the first ratio.

Specifically, the second ratio is a ratio of the amount of data written into the target entity units OB11 to OB13 to the amount of data written into the target entity unit OB21. If the second ratio corresponding to the current write operation is less than the first ratio, it indicates that the next write operation needs to be executed based on the SLC write mode in order to maintain the stability of the write speed. In contrast, if the second ratio corresponding to the current write operation is not less than the first ratio, it indicates that the next write operation needs to be executed based on the TLC write mode in order to maintain the stability of the write speed.

During the process of the aforementioned first write operation, the second ratio is 0. Since the second ratio is less than the first ratio (i.e., 1), the memory management circuit 51 switches to the SLC write mode to execute the next write operation (i.e., the second write operation in the continuous write operation).

According to the above, during the process of executing one write operation (i.e., the current write operation) in the continuous write operation, the memory management circuit 51 may determine the write mode of the next write operation according to the first ratio derived from the target write speed and the second ratio used to reflect the amount of data written into the target entity units OB11 to OB13 and OB21, so as to switch the write mode of the continuous write operation in a timely manner during the process of executing the continuous write operation. In this way, the write speed control within a small amount of data is achieved, and the stability of the write speed is improved.

On the other hand, in the disclosure, multiple target entity units OB11 to OB13 and OB21 corresponding to different write modes are adopted to store the write data of the continuous write operation. That is, in the disclosure, the multiple target entity units OB11 to OB13 and OB21 are adopted as units to manage the storage space of the rewritable non-volatile memory module 43. In this regard, in the memory management circuit 51, mapping information and/or a record table is required to be established to manage the target entity units OB11 to OB13 and OB21.

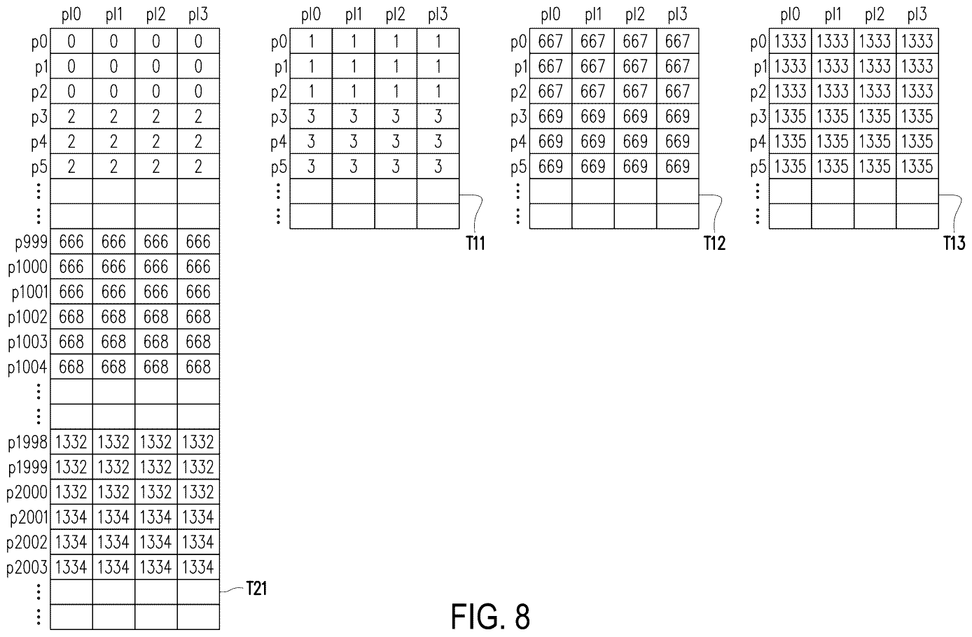

FIG. 8 is a schematic chart of logic-to-entity information according to an exemplary embodiment of the disclosure. Referring to FIG. 8, in an exemplary embodiment, the memory management circuit 51 may establish respective logic-to-entity information T11 to T13 and T21 for the target entity units OB11 to OB13 and OB21. That is, the target entity units OB11 to OB13 and OB21 respectively have their own logic-to-entity information T11 to T13 and T21. In detail, the logic-to-entity information T11 to T13 and T21 are respectively used to record a written order of the target entity units OB11 to OB13 and OB21 and a mapping relationship between entity addresses and logic addresses of the target entity units OB11 to OB13 and OB21.

As shown in FIG. 8, the memory storage device 10 has 4 entity planes pl0 to pl3, each of the target entity units OB11 to OB13 has 1,000 entity pages, and the target entity unit OB21 has 3,000 entity pages. The numbers in the logic-to-entity information T11 to T13 and T21 indicate the written order of the entity pages in the target entity units OB11 to OB13 during the continuous operation process. In other words, the smaller the number, the older the data stored in the corresponding entity page.

In an exemplary embodiment, the first ratio is 1. During the process of executing the continuous write operation, the memory management circuit 51 may first write the write data corresponding to the first write operation in the continuous write operation into the entity pages p0 to p2 of the target entity unit OB21 based on the TLC write mode, record the mapping relationship between the entity addresses of the entity pages p0 to p2 of the target entity unit OB21 and their corresponding logic addresses into the logic-to-entity information T21, and mark the entity pages p0 to p2 as number 0 in the logic-to-entity information T21.

Next, the memory management circuit 51 may switch to the SLC write mode to sequentially write the write data corresponding to the second write operation in the continuous write operation into the entity page p0 of the target entity unit OB11, write the write data corresponding to the third write operation in the continuous write operation into the entity page p1 of the target entity unit OB11, and write the write data corresponding to the fourth write operation in the continuous write operation into the entity page p2 of the target entity unit OB11.

At this point, the memory management circuit 51 may record the mapping relationship between the entity addresses of the entity pages p0 to p2 of the target entity unit OB11 and their corresponding logic addresses into the logic-to-entity information T11 and mark the entity pages p0 to p2 as number 1 in the logic-to-entity information T11.

It should be noted that although the entity pages p0 to p2 of the target entity unit OB11 store the write data corresponding to the second to fourth write operations in the continuous write operation, these three write operations are sequentially written into the target entity unit OB11 based on the same write mode. Therefore, the memory management circuit 51 regards the write order of these three write operations as the same, so as to mark the entity pages p0 to p2 as number 1 in the logic-to-entity information T11.

Thereafter, the memory management circuit 51 may switch back to the TLC write mode, write the write data corresponding to the fifth write operation in the continuous write operation into the entity pages p3 to p5 of the target entity unit OB21, record the mapping relationship between the entity addresses of the entity pages p3 to p5 of the target entity unit OB21 and their corresponding logic addresses into the logic-to-entity information T21, and mark the entity pages p3 to p5 as number 2 in the logic-to-entity information T21, and this is repeated until the continuous write operation is completed.

It should be noted that during the above process of executing the continuous write operation, the memory management circuit 51 may determine the timing of switching the write mode according to the method of FIG. 6, and description thereof is not repeated herein.

In an exemplary embodiment, the memory management circuit 51 may record the written order of the entity pages in the target entity units OB11 to OB13 and OB21 in the logic-to-entity information T11 to T13 and T21. Therefore, when multiple (more than two) entity addresses of multiple entity pages in the target entity units OB11 to OB13 and OB21 are mapped to the same logic address, the memory management circuit 51 may query a storage location of the latest data corresponding to this logic address according to the written order in the logic-to-entity information T11 to T13 and T21. That is, the memory management circuit 51 may query the latest entity address among the multiple entity addresses mapped to the same logic address from the logic-to-entity information T11 to T13 and T21.

It should be noted that in a practical application scenario, when the target entity unit OB21 corresponding to the TLC write mode is fully written, the last target entity unit OB13 corresponding to the SLC write mode may not yet be fully written. Since the information stored in the logic-to-entity information T11 to T13 and T21 reflects the actual situation of executing the continuous write operation according to the first ratio, in order to ensure the correctness of the written order in the logic-to-entity information T11 to T13 and T21, after the target entity unit OB21 is fully written, the target entity units OB11 to OB13 will no longer be used to store data.

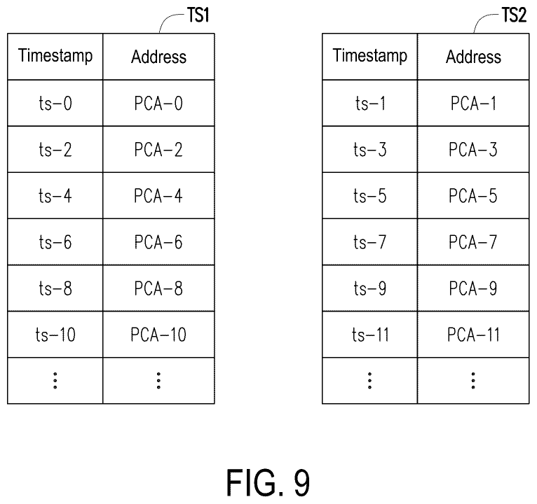

FIG. 9 is a schematic chart of a first switching time table and a second switching time table according to an exemplary embodiment of the disclosure.

Referring to FIG. 9, in addition to the above-mentioned method of using the logic-to-entity information T11 to T13 and T21 to manage the target entity units OB11 to OB13 and OB21, the disclosure further provides a first switching time table TS1 and a second switching time table TS2 as shown in FIG. 9 to manage the target entity units OB11 to OB13 and OB21.

In an exemplary embodiment, during the process of executing the continuous write operation, the memory management circuit 51 may establish the first switching time tables TS1 and TS2.

Specifically, the switching time table TS1 is used to record the entity address corresponding to the latest data stored in the target entity unit OB21 when the second write mode (e.g., TLC write mode) is switched to the first write mode (e.g., SLC write mode). Similarly, the switching time table TS2 is used to record the entity address corresponding to the latest data stored in the target entity units OB11 to OB13 when the SLC write mode is switched to the TLC write mode.

During the process of executing the continuous write operation, the memory management circuit 51 may first write the write data into the target entity unit OB21 based on the TLC write mode, then switch the write mode to write the write data into the target entity unit OB11 based on the SLC write mode, and thereafter, switch back to the TLC write mode to write the write data into the target entity unit OB21, and this is repeated until the continuous write operation is completed. Each time the write mode is switched, the memory management circuit 51 may record the entity address corresponding to the latest data stored in the target entity unit OB21 (or the target entity units OB11 to OB13) into the switching time table TS1 (or the switching time table TS2).

As shown in FIG. 9, timestamps ts-0 to ts-11 in the switching time tables TS1 and TS2 may be used to indicate a switching order of the write modes. The timestamp ts-0 indicates the first switching of the write mode, the timestamp ts-1 indicates the second switching of the write mode, and so on.

During the process of executing the continuous write operation, when the memory management circuit 51 switches the write mode for the first time (for example, switching from the TLC write mode to the SLC write mode), the memory management circuit 51 may record the timestamp ts-0 and the entity address PCA-0 corresponding to the latest data stored in the target entity unit OB21 into the switching time table TS1. Next, when the memory management circuit 51 switches the write mode again (that is, switching from the SLC write mode back to the TLC write mode), the memory management circuit 51 may record the timestamp ts-1 and the entity address PCA-1 corresponding to the latest data stored in the target entity units OB11 to OB13 into the switching time table TS2. Thereafter, when the memory management circuit 51 switches the write mode once again (that is, switching from the TLC write mode to the SLC write mode), the memory management circuit 51 may record the timestamp ts-2 and the entity address PCA-2 corresponding to the latest data stored in the target entity unit OB21 into the switching time table TS1. Other content in the switching time tables TS1 and TS2 may be deduced according to the above process.

In an exemplary embodiment, when multiple entity addresses of multiple (more than two) entity pages in the target entity units OB11 to OB13 and OB21 are mapped to the same logic address, the memory management circuit 51 may first query the multiple entity addresses corresponding to this logic address from the logic-to-entity information T11 to T13 and T21. Thereafter, the memory management circuit 51 may query multiple timestamps corresponding to the above-mentioned multiple entity addresses from the switching time tables TS1 and TS2 and determine the sequential order of the multiple timestamps, so as to determine the latest entity address among the above-mentioned multiple entity addresses.

In general, the switching time tables TS1 and TS2 may be used to indicate the sequential order in which the target entity units OB11 to OB13 and OB21 are written with data. Therefore, when multiple entity addresses of multiple (more than two) entity pages in the target entity units OB11 to OB13 and OB21 are mapped to the same logic address, the memory management circuit 51 may query the storage location of the latest data corresponding to this logic address according to the timestamps in the switching time tables TS1 and TS2.

In this way, it may be achieved that it is no longer necessary to rely on the write order recorded in the logic-to-entity information T11 to T13 and T21 to determine the newness of the data. Therefore, in the case of simultaneously adopting the logic-to-entity information T11 to T13 and T21 and the switching time tables TS1 and TS2, after the target entity unit OB21 is fully written, the one among the target entity units OB11 to OB13 that is not fully written (e.g., the target entity unit OB13) may continue to be used to store data.

In an exemplary embodiment, during the process of executing the continuous write operation, if the target entity unit that is not fully written (e.g., the target entity unit OB13) is not written with data after a predetermined duration, the target entity unit OB13 may no longer continue to be used to store data. The predetermined duration may be designed by the user according to needs, which is not limited by the disclosure. Accordingly, in the exemplary embodiments of the disclosure, it may be achieved that after the target entity unit OB21 is fully written, the remaining target entity units that are not fully written (e.g., the target entity unit OB13) may continue to be used to, so that the utilization of the rewritable non-volatile memory module 43 is improved. Further based on the predetermined duration, the problem that the target storage unit OB13 remains open for a long period without being used is avoided.

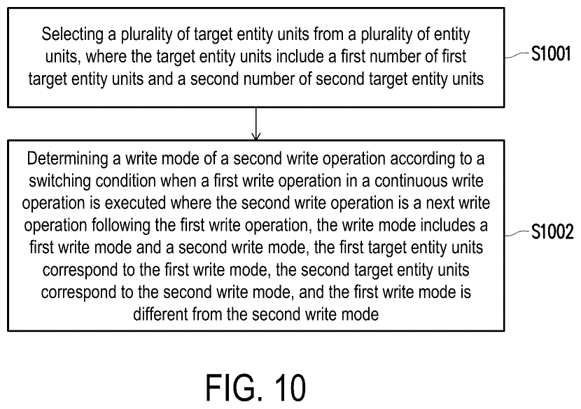

FIG. 10 is a flow chart illustrating a memory management method according to an exemplary embodiment of the disclosure. Referring to FIG. 10, in step S1001, a plurality of target entity units are selected from a plurality of entity units, where the target entity units include a first number of first target entity units and a second number of second target entity units. In step S1002, when a first write operation in a continuous write operation is executed, a write mode of a second write operation is determined according to a switching condition. The second write operation is a next write operation following the first write operation. The write mode includes a first write mode and a second write mode. The first target entity units correspond to the first write mode, and the second target entity units correspond to the second write mode. The first write mode is different from the second write mode.

However, the steps in FIG. 10 have been described in detail above, so description thereof is not repeated herein. It should be noted that each step in FIG. 10 may be implemented as a plurality of program codes or circuits, which is not particularly limited by the disclosure. In addition, the method of FIG. 10 may be used in combination with the above-described embodiments or may be used solely, which is not particularly limited by the disclosure.

In view of the foregoing, in the memory control method and the memory storage device provided in the exemplary embodiments of the disclosure, the storage space of the rewritable non-volatile memory module may be managed by using multiple target entity units as units. Further, during the process of executing the continuous write operation, the write modes of the continuous write operation are appropriately switched, and the write speed may thus be controlled within a small amount of data, and the stability of the write speed is thereby improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A memory control method for a rewritable non-volatile memory module comprising a plurality of entity units, the memory control method comprising:
selecting a plurality of target entity units from the entity units, wherein the target entity units comprise a first number of first target entity units and a second number of second target entity units; and
determining a write mode of a second write operation according to a switching condition when executing a first write operation in a continuous write operation, wherein
the second write operation is a next write operation following the first write operation, the write mode comprises a first write mode and a second write mode, the first target entity units correspond to the first write mode, the second target entity units correspond to the second write mode, and the first write mode is different from the second write mode.

2. The memory control method according to claim 1, further comprising
obtaining a first write speed, a second write speed, and a target write speed corresponding to the continuous write operation before executing the continuous write operation; and
calculating a first ratio according to the target write speed, the first write speed, and the second write speed.

3. The memory control method according to claim 2, wherein the first write speed is a write speed needed to complete the continuous write operation in the first write mode, and the second write speed is a write speed needed to complete the continuous write operation in the second write mode.

4. The memory control method according to claim 2, wherein the step of determining the write mode of the second write operation according to the switching condition comprises:
obtaining a first amount of data of the first target entity units and a second amount of data of the second target entity units;
calculating a second ratio according to the first amount of data and the second amount of data; and
determining the write mode of the second write operation according to the first ratio and the second ratio.

5. The memory control method according to claim 4, wherein the first amount of data is a written amount of data of the first target entity units, and the second amount of data is a written amount of data of the second target entity units.

6. The memory control method according to claim 1, wherein the target entity units have a plurality of pieces of logic-to-entity information used to record a written order of the target entity units and a mapping relationship between entity addresses and logic addresses of the target entity units.

7. The memory control method according to claim 6, wherein after the second target entity units are fully written, the first target entity units are no longer used to store data.

8. The memory control method according to claim 7, further comprising
querying a latest entity address among the entity addresses according to the written order of the target entity units in the logic-to-entity information if the logic addresses are mapped to the entity addresses of the target entity units.

9. The memory control method according to claim 6, further comprising
during the execution of the continuous write operation, establishing a first switching time table and a second switching time table, wherein
the first switching time table is used to record an entity address and a timestamp corresponding to latest data stored in the second target entity units when the second write mode is switched to the first write mode, and
the second switching time table is used to record an entity address and a timestamp corresponding to latest data stored in the first target entity units when the first write mode is switched to the second write mode.

10. The memory control method according to claim 9, further comprising
querying the entity addresses from the logic-to-entity information if the logic addresses are mapped to the entity addresses of the target entity units;
querying a plurality of timestamps corresponding to the entity addresses from at least one of the first switching time table and the second switching time table; and
determining a latest entity address among the entity addresses according to the timestamps.

11. A memory storage device, comprising:
a connection interface unit configured to be coupled to a host system;
a rewritable non-volatile memory module comprising a plurality of entity units; and
a memory control circuit unit coupled to the connection interface unit and the rewritable non-volatile memory module,
wherein the memory control circuit unit is configured to:
select a plurality of target entity units from the entity units, wherein the target entity units comprise a first number of first target entity units and a second number of second target entity units, and
determine a write mode of a second write operation according to a switching condition when executing a first write operation in a continuous write operation, wherein the second write operation is a next write operation following the first write operation, wherein
the write mode comprises a first write mode and a second write mode, the first target entity units correspond to the first write mode, the second target entity units correspond to the second write mode, and the first write mode is different from the second write mode.

12. The memory storage device according to claim 11, wherein before executing the continuous write operation, the memory control circuit unit is further configured to obtain a first write speed, a second write speed, and a target write speed corresponding to the continuous write operation and calculate a first ratio according to the target write speed, the first write speed, and the second write speed.

13. The memory storage device according to claim 12, wherein the first write speed is a write speed needed to complete the continuous write operation in the first write mode, and the second write speed is a write speed needed to complete the continuous write operation in the second write mode.

14. The memory storage device according to claim 12, wherein the memory control circuit unit is further configured to:
obtain a first amount of data of the first target entity units and a second amount of data of the second target entity units,
calculate a second ratio according to the first amount of data and the second amount of data, and
determine the write mode of the second write operation according to the first ratio and the second ratio.

15. The memory storage device according to claim 14, wherein the first amount of data is a written amount of data of the first target entity units, and the second amount of data is a written amount of data of the second target entity units.

16. The memory storage device according to claim 11, wherein the target entity units have a plurality of pieces of logic-to-entity information used to record a written order of the target entity units and a mapping relationship between entity addresses and logic addresses of the target entity units.

17. The memory storage device according to claim 16, wherein after the second target entity units are fully written, the first target entity units are no longer used to store data.

18. The memory storage device according to claim 17, wherein the memory control circuit unit is further configured to:
query a latest entity address among the entity addresses according to the written order of the target entity units in the logic-to-entity information if the logic addresses are mapped to the entity addresses of the target entity units.

19. The memory storage device according to claim 16, wherein the memory control circuit unit is further configured to:
during the execution of the continuous write operation, establish a first switching time table and a second switching time table, wherein
the first switching time table is used to record an entity address and a timestamp corresponding to latest data stored in the second target entity units when the second write mode is switched to the first write mode, and
the second switching time table is used to record an entity address and a timestamp corresponding to latest data stored in the first target entity units when the first write mode is switched to the second write mode.

20. The memory storage device according to claim 19, wherein the memory control circuit unit is further configured to:
query the entity addresses from the logic-to-entity information if the logic addresses are mapped to the entity addresses of the target entity units,
query a plurality of timestamps corresponding to the entity addresses from at least one of the first switching time table and the second switching time table, and
determine a latest entity address among the entity addresses according to the timestamps.
